(19) United States
(12) Patent Application Publication
(10) Pub. No.: US 2025/0344125 A1
(43) Pub. Date: Nov. 6, 2025

(54) METHODS AND APPARATUSES FOR A CONDITIONAL PRIMARY SECONDARY CELL GROUP CELL (PSCELL) ADDITION OR CHANGE (CPAC) PROCEDURE

(71) Applicant: Lenovo (Beijing) Limited, Beijing (CN)

(72) Inventors: Le Yan, Shanghai (CN); Mingzeng Dai, Shanghai (CN); Congchi Zhang, Shanghai (CN); Lianhai Wu, Beijing (CN)

(73) Assignee: Lenovo (Beijing) Limited, Beijing (CN)

(21) Appl. No.: 18/880,105

(22) PCT Filed: Jul. 1, 2022
(86) PCT No.: PCT/CN2022/103325

§ 371 Date: Dec. 30, 2024

(51) Int. Cl. H04W 36/30; H04W 36/36

(52) U.S. Cl. CPC H04W 36/305; H04W 36/362

(57) ABSTRACT

Embodiments of the present application relate to methods and apparatuses of self-optimisation (SON) enhancements for a conditional primary secondary cell group cell (PSCell) addition or change (CPAC) procedure. According to an embodiment of the present application, a user equipment (UE) includes a transceiver and a processor coupled to the transceiver; and the processor is configured to perform at least one of: storing failure related information associated with a conditional primary secondary cell group cell (PSCell) addition or change (CPAC) procedure, wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or transmitting the failure related information via the transceiver to a network.

### TECHNICAL FIELD

Embodiments of the present application generally relate to methods and apparatuses of self-optimisation (SON) enhancements for a conditional primary secondary cell group cell (PSCell) addition or change (CPAC) procedure.

### BACKGROUND

Next generation radio access network (NG-RAN) supports a multi-radio dual connectivity (MR-DC) operation. In a MR-DC scenario, a user equipment (UE) with multiple transceivers may be configured to utilize resources provided by two different nodes connected via non-ideal backhauls. One node may provide new radio (NR) access and the other one node may provide either evolved-universal terrestrial radio access (UTRA) (E-UTRA) or NR access. One node may act as a master node (MN) and the other node may act as a secondary node (SN). The MN and SN are connected via a network interface (for example, Xn interface as specified in 3rd Generation Partnership Project (3GPP) standard documents), and at least the MN is connected to the core network. MR-DC includes NR-NR DC, EN-DC, NGEN-DC, and/or NE-DC. A MN can be an eNB, a ng-eNB, or a gNB. A SN can be a ng-eNB, an en-gNB, or a gNB.

Currently, a conditional PSCell addition (CPA) procedure and a conditional PSCell change (CPC) procedure are supported. A CPAC procedure is a CPA procedure or a CPC procedure. According to agreements of 3GPP standard documents, a CPAC procedure is defined as a PSCell addition or a PSCell change that is executed by a UE when execution condition(s) configured for CPAC is met. A UE starts evaluating the execution condition(s) upon receiving CPAC configuration information, and stops evaluating the execution condition(s) once a PSCell addition and/or change procedure is triggered or executed. Currently, in a 3GPP LTE system or 5G system, details regarding SON enhancements for a CPAC procedure in a MR-DC scenario have not been discussed yet.

### SUMMARY

Some embodiments of the present application provide a user equipment (UE). The UE includes a transceiver and a processor coupled to the transceiver; and the processor is configured to perform at least one of: storing failure related information associated with a conditional primary secondary cell group cell (PSCell) addition or change (CPAC) procedure, wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or transmitting the failure related information via the transceiver to a network.

In some embodiments, the time information includes at least one of: time elapsed between initiation of last conditional reconfiguration execution towards a target PSCell and reception of latest conditional reconfiguration for the target PSCell; time elapsed between occurrence of a secondary cell group (SCG) failure when the UE is connected to a source PSCell and the reception of latest conditional reconfiguration for the CPAC procedure; or time elapsed between the initiation of the last conditional reconfiguration execution towards the target PSCell and the SCG failure.

In some embodiments, the one or two triggering events include at least one of a first triggering event or a second triggering event, and wherein, in response to the initiation of the last conditional reconfiguration execution or the occurrence of the SCG failure, the status information includes at least one of: an indication for indicating whether the first triggering event was fulfilled; an indication for indicating whether the second triggering event was fulfilled; information regarding the first triggering event in response to fulfillment of the first triggering event; information regarding the second triggering event in response to fulfillment of the second triggering event; or time duration between fulfilment timing of the first triggering event and fulfilment timing of the second triggering event.

In some embodiments, the first triggering event or the second triggering event includes at least one of: CondEvent A3; CondEvent A4; CondEvent A5; CondEvent B1; or CondEvent B2.

In some embodiments, the configuration information includes at least one of: a list of configured candidate PSCells of the CPAC procedure; one or two triggering events configured for a candidate PSCell within the list of configured candidate PSCells; an indication for indicating whether a measured neighbour PSCell is the candidate PSCell or not; or one or more measurement configurations configured for the CPAC procedure.

In some embodiments, the one or more measurement configurations include measurement identifier (ID) information to be used for the CPAC procedure.

In some embodiments, the identification information includes at least one of: a type of a PSCell change operation executed during the CPAC procedure; a type of a PSCell addition operation executed during the CPAC procedure; an indication for indicating that the PSCell change operation is executed during the CPAC procedure; an indication for indicating that the PSCell addition operation is executed during the CPAC procedure; an indication for indicating whether a last executed PSCell change operation is a conditional PSCell change (CPC) operation or not; or an indication for indicating whether a last executed PSCell addition operation is a conditional PSCell addition (CPA) operation or not.

In some embodiments, the processor of the UE is configured to transmit via the transceiver at least one of: an indication for indicating occurrence of a SCG failure before initiation of conditional reconfiguration execution towards a target PSCell; an indication for indicating occurrence of a master cell group (MCG) failure before the initiation of the conditional reconfiguration execution towards the target PSCell; an indication for indicating occurrence of a failure during the conditional reconfiguration execution towards the target PSCell; or an indication for indicating an RLF in the candidate PSCell occurring shortly after a completion of the conditional reconfiguration execution towards the target PSCell.

In some embodiments, the processor of the UE is configured to transmit, via the transceiver, an indication for indicating an optional capability of the UE for storing or transmitting the failure related information.

Some embodiments of the present application also provide a master node (MN). The MN includes a transceiver and a processor coupled to the transceiver; and the processor is configured to perform at least one of: receiving failure related information associated with a conditional primary secondary cell group (PSCell) addition or change (CPAC) procedure via the transceiver from a user equipment (UE), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; performing a mobility robustness optimization (MRO) analysis or optimization operation for parameters related to the CPAC procedure; or transmitting the failure related information via the transceiver to a secondary node (SN).

In some embodiments, the time information includes at least one of: time elapsed between initiation of last conditional reconfiguration execution towards a target PSCell and reception of latest conditional reconfiguration for the target PSCell; time elapsed between occurrence of a secondary cell group (SCG) failure when the UE is connected to a source PSCell and the reception of latest conditional reconfiguration for the CPAC procedure; or time elapsed between the initiation of the last conditional reconfiguration execution towards the target PSCell and the SCG failure.

In some embodiments, the one or two triggering events include at least one of a first triggering event or a second triggering event, and wherein, in response to the initiation of last conditional reconfiguration execution or the occurrence of the SCG failure, the status information includes at least one of: an indication for indicating whether the first triggering event was fulfilled; an indication for indicating whether the second triggering event was fulfilled; information regarding the first triggering event in response to fulfillment of the first triggering event; information regarding the second triggering event in response to fulfillment of the second triggering event; or time duration between fulfilment timing of the first triggering event and fulfilment timing of the second triggering event.

In some embodiments, the first triggering event or the second triggering event includes at least one of: CondEvent A3; CondEvent A4; CondEvent A5; CondEvent B1; or CondEvent B2.

In some embodiments, the configuration information includes at least one of: a list of configured candidate PSCells of the CPAC procedure; one or two triggering events configured for a candidate PSCell within the list of configured candidate PSCells; an indication for indicating whether a measured neighbour PSCell is the candidate PSCell or not; or one or more measurement configurations configured for the CPAC procedure.

In some embodiments, the one or more measurement configurations include measurement identifier (ID) information to be used for the CPAC procedure.

In some embodiments, the identification information includes at least one of: a type of a PSCell change operation executed during the CPAC procedure; a type of a PSCell addition operation executed during the CPAC procedure; an indication for indicating that the PSCell change operation is executed during the CPAC procedure; an indication for indicating that the PSCell addition operation is executed during the CPAC procedure; an indication for indicating whether a last executed PSCell change operation is a conditional PSCell change (CPC) operation or not; or an indication for indicating whether a last executed PSCell addition operation is a conditional PSCell addition (CPA) operation or not.

In some embodiments, the processor of the MN is configured to receive, via the transceiver from the UE, at least one of: an indication for indicating occurrence of a SCG failure before initiation of conditional reconfiguration execution towards a target PSCell; an indication for indicating occurrence of a failure during the conditional reconfiguration execution towards the target PSCell; or an indication for indicating an RLF in the candidate PSCell occurring shortly after a completion of the conditional reconfiguration execution towards the target PSCell.

In some embodiments, the processor of the MN is configured to receive, via the transceiver from the UE, an indication for indicating an optional capability of the UE for storing or transmitting the failure related information.

In some embodiments, the SN is one of: a last serving SN of the UE; and a source SN of the UE of the CPAC procedure.

In some embodiments, the processor of the MN is configured to receive, via the transceiver from the SN, one of: one or more CPAC configurations; and a container associated with the one or more CPAC configurations.

In some embodiments, the one or more CPAC configurations include at least one of: a list of configured candidate PSCells of the CPAC procedure; one or two triggering events configured for a candidate PSCell within the list of configured candidate PSCells; one or more SCG measurement configurations configured for the CPAC procedure; or an upper limit for a total number of the configured candidate PSCells.

In some embodiments, the one of the one or more CPAC configurations and the container is received in one of: a S-NODE modification required message; a SGNB modification required message; a S-NODE release request acknowledge (ACK) message; a SGNB release request acknowledge (ACK) message; a SN status transfer message; and a newly defined Xn or X2 message.

In some embodiments, the processor of the MN is configured to transmit the one of the one or more CPAC configurations and the container via the transceiver to the SN.

In some embodiments, the one of the one or more CPAC configurations and the container is transmitted in one of: a SCG failure information report message; and a newly defined Xn or X2 message.

In some embodiments, the MN is a centralized unit (CU), and wherein the processor of the CU is configured to transmit the failure related information via the transceiver to at least one distributed unit (DU) managed by the CU.

Some embodiments of the present application also provide a source secondary node (SN). The source SN includes a transceiver and a processor coupled to the transceiver; and the processor is configured to perform at least one of: receiving failure related information associated with a conditional primary secondary cell group (PSCell) addition or change (CPAC) procedure via the transceiver from a master node (MN), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or performing a mobility robustness optimization (MRO) analysis or optimization operation for parameters related to the CPAC procedure.

In some embodiments, the time information includes at least one of: time elapsed between initiation of last conditional reconfiguration execution towards a target PSCell and reception of latest conditional reconfiguration for the target PSCell; time elapsed between occurrence of a secondary cell group (SCG) failure when a user equipment (UE) is connected to a source PSCell and the reception of latest conditional reconfiguration for the CPAC procedure; or time elapsed between the initiation of the last conditional reconfiguration execution towards the target PSCell and the SCG failure.

In some embodiments, the one or two triggering events include at least one of a first triggering event or a second triggering event, and wherein, in response to the initiation of last conditional reconfiguration execution or the occurrence of the SCG failure, the status information includes at least one of: an indication for indicating whether the first triggering event was fulfilled; an indication for indicating whether the second triggering event was fulfilled; information regarding the first triggering event in response to fulfillment of the first triggering event; information regarding the second triggering event in response to fulfillment of the second triggering event; or time duration between fulfilment timing of the first triggering event and fulfilment timing of the second triggering event.

In some embodiments, the first triggering event or the second triggering event includes at least one of: CondEvent A3; CondEvent A4; CondEvent A5; CondEvent B1; or CondEvent B2.

In some embodiments, the configuration information includes at least one of: a list of configured candidate PSCells of the CPAC procedure; one or two triggering events configured for a candidate PSCell within the list of configured candidate PSCells; an indication for indicating whether a measured neighbour PSCell is the candidate PSCell or not; or one or more measurement configurations configured for the CPAC procedure.

In some embodiments, the one or more measurement configurations include measurement identifier (ID) information to be used for the CPAC procedure.

In some embodiments, the identification information includes at least one of: a type of a PSCell change operation executed during the CPAC procedure; a type of a PSCell addition operation executed during the CPAC procedure; an indication for indicating that the PSCell change operation is executed during the CPAC procedure; an indication for indicating that the PSCell addition operation is executed during the CPAC procedure; an indication for indicating whether a last executed PSCell change operation is a conditional PSCell change (CPC) operation or not; or an indication for indicating whether a last executed PSCell addition operation is a conditional PSCell addition (CPA) operation or not.

In some embodiments, the failure related information includes at least one of: an indication for indicating occurrence of a SCG failure before initiation of conditional reconfiguration execution towards a target PSCell; an indication for indicating occurrence of a failure during the conditional reconfiguration execution towards the target PSCell; or an indication for indicating an RLF in the candidate PSCell occurring shortly after a completion of the conditional reconfiguration execution towards the target PSCell.

In some embodiments, the processor of the source SN is configured to receive an indication for indicating occurrence of a master cell group (MCG) failure before initiation of conditional reconfiguration execution towards a target PSCell via the transceiver from a user equipment (UE).

In some embodiments, the processor of the source SN is configured to transmit, via the transceiver to the MN, one of: one or more CPAC configurations; and a container associated with the one or more CPAC configurations.

In some embodiments, the one or more CPAC configurations include at least one of: a list of configured candidate PSCells of the CPAC procedure; one or two triggering events configured for a candidate PSCell within the list of configured candidate PSCells; one or more SCG measurement configurations configured for the CPAC procedure; or an upper limit for a total number of the configured candidate PSCells.

In some embodiments, the one of the one or more CPAC configurations and the container is transmitted in one of: a S-NODE modification required message; a SGNB modification required message; a S-NODE release request acknowledge (ACK) message; a SGNB release request acknowledge (ACK) message; a SN status transfer message; and a newly defined Xn or X2 message.

In some embodiments, the processor of the source SN is configured to receive the one of the one or more CPAC configurations and the container via the transceiver from the MN.

In some embodiments, the one of the one or more CPAC configurations and the container is received in one of: a SCG failure information report message; and a newly defined Xn or X2 message.

In some embodiments, the source SN is a centralized unit (CU), and wherein the processor of the CU is configured to transmit the failure related information via the transceiver to at least one distributed unit (DU) managed by the CU.

Some embodiments of the present application provide a method performed by a UE. The method includes: storing failure related information associated with a conditional primary secondary cell group (PSCell) addition or change (CPAC) procedure, wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; and transmitting the failure related information to a network.

Some embodiments of the present application provide a method performed by a MN. The method includes performing at least one of: receiving failure related information associated with a conditional primary secondary cell group (PSCell) addition or change (CPAC) procedure from a user equipment (UE), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; performing a mobility robustness optimization (MRO) analysis or optimization operation for parameters related to the CPAC procedure; or transmitting the failure related information to a secondary node (SN).

Some embodiments of the present application provide a method performed by a source SN. The method includes performing at least one of: receiving failure related information associated with a conditional primary secondary cell group (PSCell) addition or change (CPAC) procedure from a master node (MN), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or performing a mobility robustness optimization (MRO) analysis or optimization operation for parameters related to the CPAC procedure.

Some embodiments of the present application provide an apparatus for wireless communications. The apparatus comprises: s: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (a MN or a source SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of transmitting failure related information in accordance with some embodiments of the present application.

FIG. 3 illustrates an exemplary flowchart of receiving failure related information in accordance with some embodiments of the present application.

FIG. 4 illustrates a further exemplary flowchart of receiving failure related information in accordance with some embodiments of the present application.

FIG. 5 illustrates an exemplary flowchart of CPAC failure information exchange in a network in accordance with some embodiments of the present application.

FIG. 6 illustrates an exemplary block diagram of an apparatus for a CPAC procedure in accordance with some embodiments of the present application.

FIG. 7 illustrates a further exemplary block diagram of an apparatus for a CPAC procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

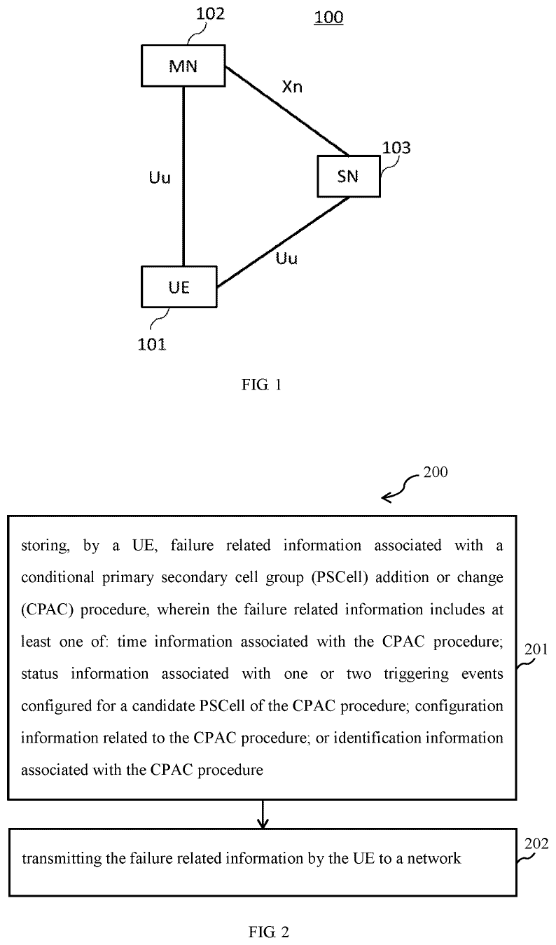

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents for NR-NR DC or NGEN-DC or NE-DC, or X2 interface as specified in 3GPP standard documents for EN-DC. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to 3GPP standard documents, CPA initiated by a MN is supported, and two types of CPC procedures are supported: a MN initiated CPC procedure; or a SN initiated CPC procedure. The “CPA” or “CPC” or “CPAC” in this disclosure means conditional PSCell addition or conditional PSCell change in a LTE-LTE DC case and any MR-DC cases, which include NR-NR DC, EN-DC, NGEN-DC, and NE-DC. In a MN initiated CPAC procedure, the MN decides a list of candidate PSCells for CPAC or generates execution condition(s) for CPAC; in a SN initiated CPC procedure, a source SN decides a list of candidate PSCells for CPAC or generates execution condition(s) for CPAC.

3GPP standard document TS38.331 introduces some events for a CPAC procedure, e.g., CondEvent A3, CondEvent A4, CondEvent A5, CondEvent B1, and Event B2, respectively.

In general, a successful PSCell change report (e.g., SPC-report) would be introduced in the 3GPP Rel-18, to optimize PSCell change or CPAC related parameters, e.g., if a physical layer issue is detected by a UE during an ongoing PSCell change procedure or an ongoing CPAC procedure. For reporting a SPC-report, configurations for the UE to log or generate the SPC-report (e.g., successPSCellChange-Config IE (information element)) is configured by a network, e.g., via an RRCReconfiguration message, including timer T304 related threshold (a threshold e.g., thresholdPercentageT304 generated by a target PSCell), timer T310 related threshold (a threshold e.g., thresholdPercentageT310 generated by a source PSCell or a source PCell), or timer T312 related threshold (a threshold e.g., thresholdPercentage T312 generated by a source PSCell or a source PCell). Based on the network configuration, the UE needs to log or generate successful PSCell change related parameters when at least one trigger condition is satisfied. A SPC-report can be generated and reported to the network, including cell global identifier (CGI) information of the source PSCell, CGI information of the target PSCell, cause value for successful PSCell change report (e.g., t304-cause, t310-cause, or t312-cause), and measurement results.

Currently, a purpose of a SCG failure information procedure is to inform E-UTRAN or NR MN about a SCG failure the UE has experienced. A SCG failure type includes a SCG radio link failure, a failure of SCG reconfiguration with sync, a SCG configuration failure for an RRC message on signalling radio bearer (SRB) 3, a SCG integrity check failure, and a consistent uplink LBT failure on a PSCell for operation with shared spectrum channel access. A SCG failure type, measurement result(s) in MCG, and/or measurement result(s) in SCG can be included in a SCG failure information message. After the network receives the SCG failure information message, it can trigger the UE to perform a SN release or modification or change procedure. The following information can also be included in the SCG failure information message in case of a SCG failure: previous PSCell ID (i.e., PCI); failed PSCell ID (i.e., PCI); time SCG failure and/or RA-Information.

Currently, there is no mechanism of SON enhancements for a CPAC procedure in a MR-DC scenario. Embodiments of the present application aim to resolve the abovementioned problem. Some embodiments of the present application define information needed to be reported to a network for a MRO purpose considering different failure cases in a CPAC procedure. Some embodiments of the present application define signalling exchange for CPAC failure related information between RAN nodes, e.g., between a MN and a SN, or in CU-DU split architecture.

More specifically, in some embodiments of the present application, failure related information associated with a CPAC procedure includes at least one of time related information associated with a CPAC procedure, status information associated with CPAC triggering event(s) or condition(s), and/or type of conditional PSCell change or addition procedure may be logged and reported by a UE to a network (e.g., a MN or a SN) for a MRO purpose.

In some embodiments of the present application, a source SN sends one container (e.g., SN Mobility Information IE) to a MN via an existing message (e.g., a SN Release Request ACK message or a SN Status Transfer message) or via a newly defined Xn or X2 message. In some other embodiments of the present application, a source SN may transmit latest CPAC configuration(s) to a MN via an existing message (e.g., a SN release request ACK message or a SN status transfer message) or via a newly defined Xn or X2 message. For a MRO purpose, the MN may transmit the received latest CPAC configuration(s) to the source SN via a newly defined Xn or X2 message or a SCG FAILURE INFORMATION REPORT message, e.g., after receiving failure related information or a SCG failure information message from the UE.

In some embodiments of the present application, failure related information associated with a CPAC procedure is exchanged between a MN and a source SN or between a MN and a last serving SN. For instance, in CU-DU split architecture, BS-CU (e.g., gNB-CU) may transfer failure related information associated with a CPAC procedure to BS-DU (e.g., gNB-DU). Some embodiments of the present application introduce a UE's optional capability for storing or reporting failure related information associated with a CPAC procedure. More details regarding the embodiments of the present application will be illustrated in the following text in combination with the appended drawings.

In a CPAC procedure, after receiving CPAC configuration(s) or conditional reconfiguration for the CPAC procedure, a UE decides whether or when to perform a CPAC execution (e.g., performing a PSCell change towards a target PSCell in which the corresponding CPC execution is fulfilled, or performing a PSCell addition towards a target PSCell in which the corresponding CPA execution is fulfilled). A failure (e.g., a SCG radio link failure, a failure of a CPAC execution, a CPAC execution failure, or a failure of SCG reconfiguration with sync) in the CPAC procedure would impact system performance, a MRO function for the CPAC procedure should be considered. In some embodiments of the present application, assistance information e.g., SCG failure related information or failure related information associated with a CPAC procedure which is beneficial for a MRO purpose, is illustrated in embodiments of FIGS. 2-4 as below.

FIG. 2 illustrates an exemplary flowchart of transmitting failure related information in accordance with some embodiments of the present application. The exemplary procedure 200 in the embodiments of FIG. 2 may be performed by a UE, e.g., UE 101 as shown in FIG. 1. Although described with respect to a UE, it should be understood that other devices may be configured to perform a method similar to that of FIG. 2. In the embodiments of FIG. 2, both operation 201 and operation 202 are performed. In some other embodiments, only operation 201 or operation 202 as shown in FIG. 2 is performed, without departing from the spirit and scope of the disclosure.

In the exemplary procedure 200 as shown in FIG. 2, in operation 201, a UE may store failure related information associated with a CPAC procedure. In FIG. 2, “a failure” or “a SCG failure” means a SCG radio link failure (RLF), a failure of a CPAC execution, a CPAC execution failure, or a failure of SCG reconfiguration with sync. The failure related information associated with the CPAC procedure may also be named as “CPAC failure related information” or “SCG failure related information for CPAC procedure” or the like. The failure related information associated with the CPAC procedure may include at least one of:
(1) time information associated with the CPAC procedure;
(2) status information associated with one or two triggering events configured for a candidate PSCell of the CPAC procedure;
(3) configuration information related to the CPAC procedure; or
(4) identification information associated with the CPAC procedure.

In operation 202, the UE may transmit the failure related information to a network, e.g., a MN (e.g., MN 102 as shown in FIG. 1) or a SN (e.g., SN 103 as shown in FIG. 1) or a network node where the UE connects to or re-establishes to after a failure. For example, the UE may transmit the failure related information to the MN via a SCG failure information message. Optionally, before operation 202, the UE transmits an indication for indicating storing failure related information associated with the CPAC procedure to the network; the UE receives a request for the failure related information associated with the CPAC procedure from the network; and then, in operation 202, the UE transmits the stored failure related information to the network.

In some embodiments, the time information associated with the CPAC procedure includes at least one of:
(1) time elapsed between “initiation of last conditional reconfiguration execution towards a target PSCell” and “reception of latest conditional reconfiguration for the target PSCell”, or time elapsed between “CPAC execution” and “reception of latest conditional reconfiguration for the CPAC procedure”;
(2) time elapsed between “occurrence of a SCG failure when the UE is connected to a source PSCell” and “the reception of latest conditional reconfiguration for the CPAC procedure”, for example, the SCG failure may be an RLF in a source SCG; or time elapsed between “occurrence of a SCG failure in source SCG” and “reception of latest conditional reconfiguration for the CPAC procedure”; or
(3) time elapsed between “the initiation of the last conditional reconfiguration execution towards the target PSCell” and “the SCG failure”, or, time elapsed between “CPAC execution” and “occurrence of a failure of the CPAC execution or a CPAC execution failure”. For example, the SCG failure may be an RLF in a target SCG or a failure of the CPAC execution or a CPAC execution failure. A failure of the CPAC execution or a CPAC execution failure may include, e.g., a PSCell change towards a target PSCell in which the corresponding CPC execution is fulfilled fails, or a PSCell addition towards a target PSCell in which the corresponding CPA execution is fulfilled fails, or a failure of SCG reconfiguration with sync occurs.

In some embodiments, the one or two triggering events configured for the candidate PSCell include at least one of a triggering event (denoted as “the first triggering event” for simplicity) or another triggering event (denoted as “the second triggering event” for simplicity). In response to the initiation of the last conditional reconfiguration execution or the occurrence of the SCG failure, the status information, which is associated with the one or two triggering events, may include at least one of:
(1) an indication for indicating whether the first triggering event was fulfilled;
(2) an indication for indicating whether the second triggering event was fulfilled;
(3) information regarding the first triggering event in response to fulfillment of the first triggering event;
(4) information regarding the second triggering event in response to fulfillment of the second triggering event; or
(5) time duration between fulfilment timing of the first triggering event and fulfilment timing of the second triggering event, e.g., for a case that these two triggering events are both fulfilled.

In some embodiments, the first triggering event or the second triggering event may include at least one of: CondEvent A3; CondEvent A4; CondEvent A5; CondEvent B1; or CondEvent B2.

In some embodiments, the configuration information, which is related to the CPAC procedure, includes at least one of:
(1) a list of configured candidate PSCells of the CPAC procedure;
(2) one or two triggering events configured for a candidate PSCell within the list of configured candidate PSCells;
(3) an indication for indicating whether a measured neighbour PSCell is the candidate PSCell or not; or
(4) one or more measurement configurations configured for the CPAC procedure. In an embodiment, the one or more measurement configurations include measurement identifier (ID) information to be used for the CPAC procedure.

In some embodiments, the identification information, which is associated with the CPAC procedure, includes at least one of:
(1) a type of a PSCell change operation executed during the CPAC procedure, or a type of a CPC procedure;
(2) a type of a PSCell addition operation executed during the CPAC procedure, or a type of a CPA procedure;
(3) an indication for indicating that the PSCell change operation is executed during the CPAC procedure, or an indication for a CPC procedure;
(4) an indication for indicating that the PSCell addition operation is executed during the CPAC procedure, or an indication for a CPA procedure;
(5) an indication for indicating whether a last executed PSCell change operation is a CPC operation or not; or
(6) an indication for indicating whether a last executed PSCell addition operation is a CPA operation or not.

In some embodiments, the UE may transmit at least one of:
(1) an indication for indicating occurrence of a SCG failure before initiation of conditional reconfiguration execution towards a target PSCell;
(2) an indication for indicating occurrence of a MCG failure before the initiation of the conditional reconfiguration execution towards the target PSCell;
(3) an indication for indicating occurrence of a failure during the conditional reconfiguration execution towards the target PSCell, or an indication for a CPAC execution failure; or
(4) an indication for indicating an RLF in the candidate PSCell occurring shortly after a completion of the conditional reconfiguration execution towards the target PSCell.

In some embodiments, the UE may transmit an indication for indicating an optional capability of the UE for storing or transmitting the failure related information, i.e., the CPAC failure related information. For instance, in an embodiment of the present application introducing an UE's optional capability for storing or reporting CPAC failure related information, there are two potential options:
(1) Option 1: Optional with capability signalling. Storing or reporting the CPAC failure related information is optional, even if the UE supports a PSCell change or CPAC mechanism. This capability may be explicitly signalled by the UE to a network, i.e., introducing an optional UE's capability with signalling for storing or reporting CPAC failure related information, e.g., including an optional UE's capability indication for storing or reporting the CPAC failure related information in a UE capability information message.
(2) Option 2: Optional without capability signalling. Storing or reporting the CPAC failure related information is optional, even if the UE supports a PSCell change or CPAC mechanism, and no explicit capability bit is signalled by the UE.

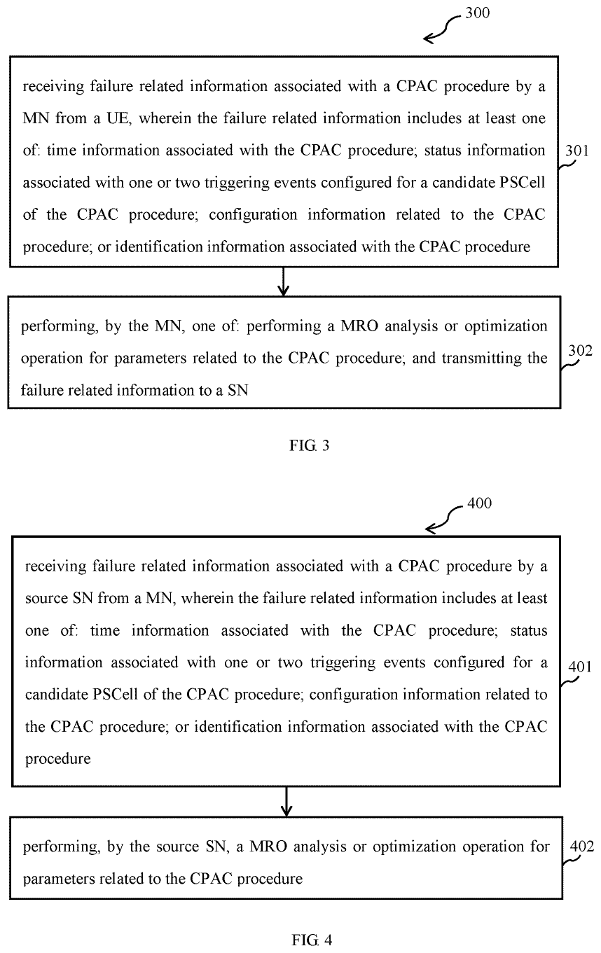

FIG. 3 illustrates an exemplary flowchart of receiving failure related information in accordance with some embodiments of the present application. The exemplary procedure 300 in the embodiments of FIG. 3 may be performed by a MN, e.g., MN 102 as shown in FIG. 1. Although described with respect to a MN, it should be understood that other devices may be configured to perform a method similar to that of FIG. 3. In FIG. 3, “a failure” or “a SCG failure” means a SCG RLF, a failure of a CPAC execution, a CPAC execution failure, or a failure of SCG reconfiguration with sync. In the embodiments of FIG. 3, both operation 301 and operation 302 are performed. In some other embodiments, only operation 301 or operation 302 as shown in FIG. 3 is performed, without departing from the spirit and scope of the disclosure.

In the exemplary procedure 300 as shown in FIG. 3, in operation 301, a MN receives failure related information associated with a CPAC procedure from a UE (e.g., UE 101 as shown in FIG. 1), or a network node where the UE connects to or re-establishes to after failure, this network node receives the failure related information associated with a CPAC procedure from the UE. The failure related information associated with the CPAC procedure may also be named as “CPAC failure related information” or “SCG failure related information for CPAC procedure” or the like. The failure related information associated with the CPAC procedure may include at least one of:
(1) time information associated with the CPAC procedure;
(2) status information associated with one or two triggering events configured for a candidate PSCell of the CPAC procedure;
(3) configuration information related to the CPAC procedure; or
(4) identification information associated with the CPAC procedure.

In operation 302, the MN may perform one of the following:
(1) performing a MRO analysis or optimization operation for parameters related to the CPAC procedure; and
(2) transmitting the failure related information to a SN (e.g., source SN 103 as shown in FIG. 1, or a last serving SN which is not shown in FIG. 1). In some embodiments, the SN may be one of: a last serving SN of the UE; and a source SN of the UE of the CPAC procedure.

In some embodiments, the time information includes at least one of:
(1) time elapsed between initiation of last conditional reconfiguration execution towards a target PSCell and reception of latest conditional reconfiguration for the target PSCell, or time elapsed between “CPAC execution” and “reception of latest conditional reconfiguration for the CPAC procedure”;
(2) time elapsed between occurrence of a SCG failure when the UE is connected to a source PSCell and the reception of latest conditional reconfiguration for the CPAC procedure, for example, the SCG failure may be an RLF in a source SCG; or time elapsed between “occurrence of a SCG failure in source SCG” and “reception of latest conditional reconfiguration for the CPAC procedure”; or
(3) time elapsed between the initiation of the last conditional reconfiguration execution towards the target PSCell and the SCG failure, or, time elapsed between “CPAC execution” and “occurrence of a failure of the CPAC execution or a CPAC execution failure”. For example, the SCG failure may be an RLF in a target SCG or a failure of the CPAC execution or a CPAC execution failure. A failure of the CPAC execution or a CPAC execution failure may include, e.g., a PSCell change towards a target PSCell in which the corresponding CPC execution is fulfilled fails, or a PSCell addition towards a target PSCell in which the corresponding CPA execution is fulfilled fails, or a failure of SCG reconfiguration with sync occurs.

In some embodiments, the one or two triggering events include at least one of a triggering event (denoted as “the first triggering event” for simplicity) or another triggering event (denoted as “the second triggering event” for simplicity). In response to the initiation of last conditional reconfiguration execution or the occurrence of the SCG failure, the status information includes at least one of:
(1) an indication for indicating whether the first triggering event was fulfilled;
(2) an indication for indicating whether the second triggering event was fulfilled;
(3) information regarding the first triggering event in response to fulfillment of the first triggering event;
(4) information regarding the second triggering event in response to fulfillment of the second triggering event; or
(5) time duration between fulfilment timing of the first triggering event and fulfilment timing of the second triggering event, e.g., for that case that these two triggering events are both fulfilled.

In some embodiments, the first triggering event or the second triggering event includes at least one of: CondEvent A3; CondEvent A4; CondEvent A5; CondEvent B1; or CondEvent B2.

In some embodiments, the configuration information includes at least one of:
(1) a list of configured candidate PSCells of the CPAC procedure;
(2) one or two triggering events configured for a candidate PSCell within the list of configured candidate PSCells;
(3) an indication for indicating whether a measured neighbour PSCell is the candidate PSCell or not; or
(4) one or more measurement configurations configured for the CPAC procedure. In some embodiments, the one or more measurement configurations include measurement ID information to be used for the CPAC procedure.

In some embodiments, the identification information, which is associated with the CPAC procedure, includes at least one of:
(1) a type of a PSCell change operation executed during the CPAC procedure, or a type of a CPC procedure;
(2) a type of a PSCell addition operation executed during the CPAC procedure, or a type of a CPA procedure;
(3) an indication for indicating that the PSCell change operation is executed during the CPAC procedure, or an indication for a CPC procedure;
(4) an indication for indicating that the PSCell addition operation is executed during the CPAC procedure, or an indication for a CPA procedure;
(5) an indication for indicating whether a last executed PSCell change operation is a conditional PSCell change (CPC) operation or not; or
(6) an indication for indicating whether a last executed PSCell addition operation is a conditional PSCell addition (CPA) operation or not.

In some embodiments, the MN may receive, from the UE, at least one of:
(1) an indication for indicating occurrence of a SCG failure before initiation of conditional reconfiguration execution towards a target PSCell;
(2) an indication for indicating occurrence of a failure during the conditional reconfiguration execution towards the target PSCell, or an indication for a CPAC execution failure; or
(3) an indication for indicating an RLF in the candidate PSCell occurring shortly after a completion of the conditional reconfiguration execution towards the target PSCell.

In some embodiments, the MN may receive, from the UE, an indication for indicating an optional capability of the UE for storing or transmitting the failure related information.

In some embodiments, the MN may receive, from the source SN, one of: one or more CPAC configurations; and a container associated with the one or more CPAC configurations. The container may be represented by an information element (IE), e.g., SN Mobility Information, or by an index. In an embodiment, the one or more CPAC configurations include at least one of:
(1) a list of configured candidate PSCells of the CPAC procedure;
(2) one or two triggering events configured for a candidate PSCell within the list of configured candidate PSCells;
(3) one or more SCG measurement configurations configured for the CPAC procedure; or
(4) an upper limit for a total number of the configured candidate PSCells.

In some embodiments, the one of the one or more CPAC configurations and the container is received in one of:
(1) a S-NODE modification required message;
(2) a SGNB modification required message;
(3) a S-NODE release request acknowledge (ACK) message;
(4) a SGNB release request acknowledge (ACK) message;
(5) a SN status transfer message; and
(6) a newly defined Xn or X2 message.

In some embodiments, the MN may transmit the one of the one or more CPAC configurations and the container to the source SN or the last serving SN. In an embodiment, the one or more CPAC configurations or the container is transmitted in a SCG failure information report message or a newly defined Xn or X2 message. In an embodiment, the one or more CPAC configurations or the container is transmitted to the source SN or the last serving SN after reception of the failure related information.

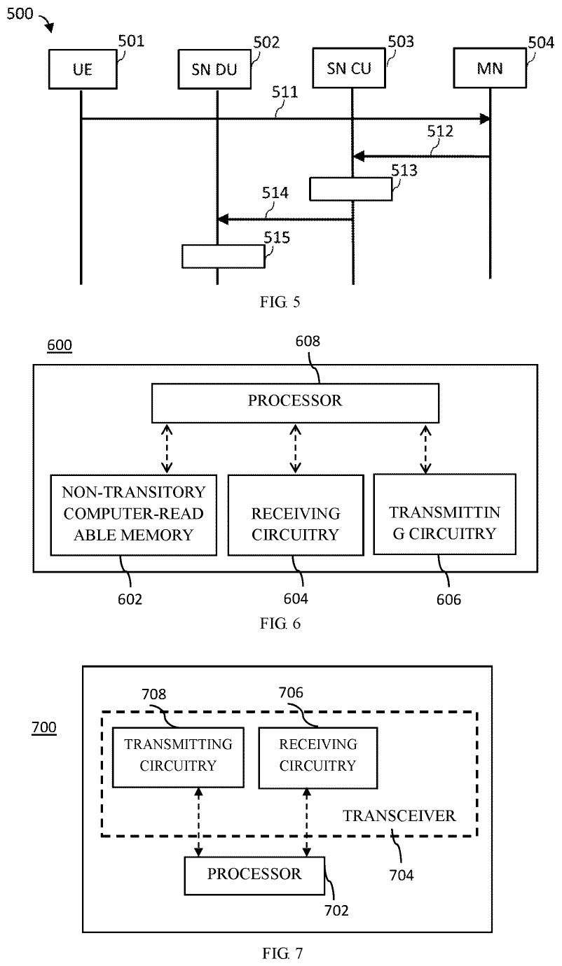

In some embodiments, the MN is a centralized unit (CU). The CU may transmit the failure related information associated with the CPAC procedure to at least one distributed unit (DU) managed by the CU. A specific example is described in the embodiments of FIG. 5 as below.

FIG. 4 illustrates a further exemplary flowchart of receiving failure related information in accordance with some embodiments of the present application. The exemplary procedure 400 in the embodiments of FIG. 4 may be performed by a source SN, e.g., SN 103 as shown in FIG. 1. Although described with respect to a source SN, it should be understood that other devices may be configured to perform a method similar to that of FIG. 4. In FIG. 4, “a failure” or “a SCG failure” means a SCG RLF, a failure of a CPAC execution, a CPAC execution failure, or a failure of SCG reconfiguration with sync. In the embodiments of FIG. 4, both operation 401 and operation 402 are performed. In some other embodiments, only operation 401 or operation 402 as shown in FIG. 4 is performed, without departing from the spirit and scope of the disclosure.

In the exemplary procedure 400 as shown in FIG. 4, in operation 401, a source SN receives failure related information associated with a CPAC procedure from a MN. The failure related information associated with the CPAC procedure includes at least one of:
(1) time information associated with the CPAC procedure;
(2) status information associated with one or two triggering events configured for a candidate PSCell of the CPAC procedure;
(3) configuration information related to the CPAC procedure; or
(4) identification information associated with the CPAC procedure.

In operation 402, the source SN performs a mobility robustness optimization (MRO) analysis or optimization operation for parameters related to the CPAC procedure.

In some embodiments, the time information includes at least one of:
(1) time elapsed between initiation of last conditional reconfiguration execution towards a target PSCell and reception of latest conditional reconfiguration for the target PSCell, or time elapsed between “CPAC execution” and “reception of latest conditional reconfiguration for the CPAC procedure”;
(2) time elapsed between occurrence of a secondary cell group (SCG) failure when a user equipment (UE) is connected to a source PSCell and the reception of latest conditional reconfiguration for the CPAC procedure, for example, the SCG failure may be an RLF in a source SCG; or time elapsed between “occurrence of a SCG failure in source SCG” and “reception of latest conditional reconfiguration for the CPAC procedure”; or
(3) time elapsed between the initiation of the last conditional reconfiguration execution towards the target PSCell and the SCG failure, or, time elapsed between “CPAC execution” and “occurrence of a failure of the CPAC execution or a CPAC execution failure”. For example, the SCG failure may be an RLF in a target SCG or a failure of the CPAC execution or a CPAC execution failure. A failure of the CPAC execution or a CPAC execution failure may include, e.g., a PSCell change towards a target PSCell in which the corresponding CPC execution is fulfilled fails, or a PSCell addition towards a target PSCell in which the corresponding CPA execution is fulfilled fails, or a failure of SCG reconfiguration with sync occurs.

In some embodiments, the one or two triggering events include at least one of a triggering event (denoted as “the first triggering event” for simplicity) or another triggering event (denoted as “the second triggering event” for simplicity). In response to the initiation of last conditional reconfiguration execution or the occurrence of the SCG failure, the status information includes at least one of:
(1) an indication for indicating whether the first triggering event was fulfilled; an indication for indicating whether the second triggering event was fulfilled;
(2) information regarding the first triggering event in response to fulfillment of the first triggering event;
(3) information regarding the second triggering event in response to fulfillment of the second triggering event; or
(4) time duration between fulfilment timing of the first triggering event and fulfilment timing of the second triggering event, e.g., for a case that these two triggering events are both fulfilled. In the embodiments of FIGS. 2, 3, and 4, the first or second triggering event may also be named as the first or second triggering condition or the like.

In some embodiments, the first triggering event or the second triggering event includes at least one of: CondEvent A3; CondEvent A4; CondEvent A5; CondEvent B1; or CondEvent B2.

In some embodiments, the configuration information, which is related to the CPAC procedure, includes at least one of:
(1) a list of configured candidate PSCells of the CPAC procedure;
(2) one or two triggering events configured for a candidate PSCell within the list of configured candidate PSCells;
(3) an indication for indicating whether a measured neighbour PSCell is the candidate PSCell or not; or
(4) one or more measurement configurations configured for the CPAC procedure. In some embodiments, the one or more measurement configurations include measurement identifier (ID) information to be used for the CPAC procedure.

In some embodiments, the identification information, which is associated with the CPAC procedure, includes at least one of:
(1) a type of a PSCell change operation executed during the CPAC procedure, or a type of a CPC procedure;
(2) a type of a PSCell addition operation executed during the CPAC procedure, or a type of a CPA procedure;
(3) an indication for indicating that the PSCell change operation is executed during the CPAC procedure, or an indication for a CPC procedure;
(4) an indication for indicating that the PSCell addition operation is executed during the CPAC procedure, or an indication for a CPA procedure;
(5) an indication for indicating whether a last executed PSCell change operation is a conditional PSCell change (CPC) operation or not; or
(6) an indication for indicating whether a last executed PSCell addition operation is a conditional PSCell addition (CPA) operation or not.

In some embodiments, the failure related information includes at least one of:
(1) an indication for indicating occurrence of a SCG failure before initiation of conditional reconfiguration execution towards a target PSCell;
(2) an indication for indicating occurrence of a failure during the conditional reconfiguration execution towards the target PSCell, or an indication for a CPAC execution failure; or
(3) an indication for indicating an RLF in the candidate PSCell occurring shortly after a completion of the conditional reconfiguration execution towards the target PSCell.

In some embodiments, the source SN may receive an indication for indicating occurrence of a master cell group (MCG) failure before initiation of conditional reconfiguration execution towards a target PSCell from a user equipment (UE).

In some embodiments, the source SN may transmit, to the MN, one of: one or more CPAC configurations; and a container associated with the one or more CPAC configurations. In an embodiment, the one or more CPAC configurations include at least one of:
(1) a list of configured candidate PSCells of the CPAC procedure;
(2) one or two triggering events configured for a candidate PSCell within the list of configured candidate PSCells;
(3) one or more SCG measurement configurations configured for the CPAC procedure; or
(4) an upper limit for a total number of the configured candidate PSCells.

In some embodiments, the one of the one or more CPAC configurations and the container is transmitted in one of:
(1) a S-NODE modification required message;
(2) a SGNB modification required message;
(3) a S-NODE release request ACK message;
(4) a SGNB release request ACK message;
(5) a SN status transfer message; and
(6) a newly defined Xn or X2 message.

In some embodiments, the source SN may receive the one of the one or more CPAC configurations and the container from the MN. In an embodiment, the one or more CPAC configurations or the container is received in one of: a SCG failure information report message; and a newly defined Xn or X2 message.

In some embodiments, the source SN is a CU. The CU may transmit the failure related information to at least one DU managed by the CU. A specific example is described in the embodiments of FIG. 5 as below.

Details described in all other embodiments of the present application are applicable for the embodiments shown in any of FIGS. 2-4. It should be appreciated by persons skilled in the art that the sequence of the operations in any of exemplary procedures 200-400 in FIGS. 2-4 may be changed and some of the operations in any of exemplary procedures 200-400 in FIGS. 2-4 may be eliminated or modified, without departing from the spirit and scope of the disclosure.

The following texts describe specific Embodiments 1-1, 1-2, and 1-3 of the embodiments as shown and illustrated in FIGS. 2-4, in which a UE and a network node (e.g., a MN, a source SN, or a target SN) perform following operations.

Embodiment 1-1: a UE may store, log, record, or generate time information, and status information associated with CPAC triggering event(s), or the UE may report time information, and status information associated with CPAC triggering event(s).

In Embodiment 1-1, in case that a CPAC execution failure occurs, to enable a network to decide whether CPAC execution condition(s) are configured properly or not, it is necessary for a UE to store or report the time elapsed between the CPAC execution (i.e., the execution of a CPAC procedure) towards a target PSCell and timing when the corresponding latest CPAC configuration is received for the target PSCell. For example, if this reported time duration is long, the network may understand that CPAC configuration(s) are not suitable. Then, the network may trigger a legacy PSCell change procedure before the CPAC execution, or may loosen the CPAC execution condition(s), e.g., the network may decrease the reference signal received power (RSRP) trigger threshold or a reference signal received quality (RSRQ) trigger threshold or a signal to interference plus noise ratio (SINR) trigger threshold for the CPAC procedure, or the network may decrease time to trigger (TTT) value for the CPAC evaluation.

In Embodiment 1-1, in case that a SCG failure occurs in source SN before the CPAC execution, to enable the network to decide whether the CPAC execution condition(s) or CPAC candidate PSCell(s) are configured properly or not, it is necessary for the UE to store or report the time elapsed between “occurrence of the SCG failure in a source SCG” and “timing when the latest CPAC configuration is received”. For example, if this reported time duration is long, the network may understand that the SCG failure may be caused due to strict CPAC execution condition(s), and then, the network may loosen the CPAC execution condition(s).

In Embodiment 1-1, for time information, a new time IE (e.g., timeSinceCPACReconfig) may be introduced, e.g., in a SCG failure information message or an RLF report. There may be following two cases:
(1) In case that a PSCell change failure or a PSCell addition failure occurs during the CPAC procedure (i.e., a PSCell change or addition failure occurs when the UE tries to access to a target PSCell while having CPAC configuration(s), or a CPAC execution failure), the UE may store, log, record, or generate the time elapsed between “the initiation of the last conditional reconfiguration execution towards the target PSCell” and “the reception of the latest conditional reconfiguration for this target PSCell”, i.e., time elapsed between “the CPAC execution towards the target PSCell” and “timing when the corresponding latest CPAC configuration is received for the target PSCell”.
(2) In case that the UE experiences an RLF in a source SCG after being configured with CPC configuration(s) and before the CPC procedure is executed (i.e., an RLF in a source PSCell occurs while having CPC configuration(s)), the UE may store, log, record, or generate the time elapsed between “occurrence of the SCG failure in the source SCG” and “the reception of the latest conditional reconfiguration(s) for the CPC procedure when the UE is connected to the source PSCell”.

In Embodiment 1-1, there may be a case that at most two triggering events or conditions are configured for one CPAC candidate PSCell. If two triggering events or conditions are configured for one CPAC candidate PSCell, a CPAC execution is performed only when these two triggering events or conditions for the candidate PSCell are both fulfilled. When a failure (e.g., a CPAC execution failure in a target PSCell or an RLF in a source SCG) occurs, it means that at least one trigger event or condition is not suitable. In order to let the network know more information for modifying CPAC execution condition(s), the following status information associated with CPAC triggering event(s) or condition(s) may be stored at the moment of conditional reconfiguration execution or an SCG radio link failure, and reported in a message, e.g., the SCG failure information message or an RLF report:
(1) an indication for indicating whether a triggering event (e.g., a first triggering event), e.g., CondEvent A3, A4, A5, B1 and/or B2, for one CPAC candidate PSCell or target PSCell was fulfilled;
(2) an indication for indicating whether another triggering event (e.g., a second triggering event), i.e., CondEvent A3, A4, A5, B1 and/or B2, for the CPAC candidate PSCell or target PSCell was fulfilled;
(3) information regarding the first triggering event, if the first triggering event for the CPAC candidate PSCell or target PSCell was fulfilled, e.g., a firstTriggeredEvent IE is set to the execution condition or event (e.g., condFirstEvent) which was fulfilled firstly in time;
(4) information regarding the second triggering event, if the second triggering event for the CPAC candidate PSCell or target PSCell was fulfilled, e.g., a firstTriggeredEvent IE is set to the execution condition or event (e.g., condSecondEvent) which was fulfilled firstly in time; and/or
(5) time duration between fulfilment of these two triggering events or conditions configured for the CPAC candidate PSCell or target PSCell in which the CPAC execution was triggered. The first or second triggering event may also be named as the first or second triggering condition or the like.

Additionally, the UE may store or report time elapsed between the initiation of the last conditional reconfiguration execution towards the target PSCell and the SCG failure. In 3GPP Rel-17, “timeSCGFailure IE” is introduced in the SCG failure information message to indicate the time elapsed since “the last execution of RRCReconfiguration with reconfigurationWithSync for the SCG” until “occurrence of a SCG failure”. In Embodiment 1-1, for a CPAC procedure, the timeSCGFailure IE in the SCG failure information message may be reused to indicate the time elapsed since “the last CPAC or conditional reconfiguration execution towards the target PSCell” until “occurrence of a SCG failure”, i.e., the time elapsed since “executing the last PSCell change towards the target PSCell” until “the PSCell change failure or an RLF occurs shortly after the successful PSCell change”. Alternatively, in Embodiment 1-1, a new IE in the SCG failure information message may be introduced to indicate the time elapsed since “the last CPAC or conditional reconfiguration execution towards the target PSCell” until “occurrence of the SCG failure”.

In Embodiment 1-1, if it is a MN initiated CPAC procedure, the MN may use received time information and status information associated with CPAC triggering event(s) or condition(s) for a MRO purpose. Additionally, the MN may send the time information and/or status information associated with the CPAC triggering event(s) or condition(s) to the last serving SN or the source SN via a newly defined Xn or X2 message or an existing message (e.g., a SCG FAILURE INFORMATION REPORT message), for example, for a SN initiated CPAC procedure. Then, the last serving SN or the source SN may use the received information for the MRO purpose.

In Embodiment 1-1, for the case that the CPAC execution is successful, a new IE (e.g., timeSinceCPACReconfig) may be generated or reported in a successful PSCell change report (SPC-report). For instance, the new IE may indicate the time elapsed between “the initiation of the last conditional reconfiguration execution towards the target PSCell” and “the reception of the latest conditional reconfiguration for this target PSCell for the CPAC procedure”. The time elapsed since “the last execution of RRCReconfiguration with reconfigurationWithSync for PSCell” until “successful PSCell change”, or the time elapsed between “the initiation of the last CPAC or conditional reconfiguration execution towards the target PSCell” and “the successful PSCell change” may also be stored or reported by the UE, e.g., via the SPC-report.

Embodiment 1-2: a UE may store or report CPAC related configuration(s) for a MRO purpose.

In particular, in Embodiment 1-2, to analyse whether CPAC configuration(s) are set properly, e.g., whether CPAC execution condition(s) are configured properly, or whether configured CPAC candidate PSCell(s) (i.e., candidate PSCell(s) of the CPAC procedure) are suitable, it is beneficial for the network to know the configured CPAC configuration(s) for MRO analysis, especially, when the network does not have CPAC related parameters, e.g., when a UE's context is released, or when the network is not involved with the CPAC procedure. There may be following two solutions in Embodiment 1-2, i.e., Solution 1 (a UE based solution) and Solution 2 (a network based solution).

Solution 1 refers to a UE based solution. In Solution 1, a UE may store or report the latest configured CPAC configuration(s) to the network. For example, at least one of the following information may be included in a message, e.g., a SCG failure information message or an RLF report, which is sent by the UE to the network:
(1) Latest received CPAC execution condition(s) (e.g., configuration related to CondEvent A3, A4, A5, B1 and/or B2, and/or TTT values) which is configured for any CPAC candidate PSCell, i.e., latest received one or two triggering events for any candidate PSCell within the list of configured candidate PSCells.
(2) Latest radio measurement results of CPAC candidate PSCell(s). For example, the existing measResultSCG-Failure or measResultListNR or measResultNeighCells IE in the SCG failure information message or an RLF report may be reused to represent the latest radio measurement results.
(3) An indication for indicating that whether a measured neighbour PSCell included in the measurement results was a CPAC candidate PSCell or not. For example, an existing measResultSCG-Failure or measResultListNR or measResultNeighCells IE or other IE in the SCG Failure Information message or an RLF report may be reused to include measurement results. An indication may be included in the IE, to indicate whether the measured neighbour PSCell was configured as the CPAC candidate PSCell or not.
(4) A list of the latest configured CPAC candidate PSCells. For example, the list may include cell related information of the latest configured CPAC candidate PSCells. The cell related information may include a global cell identity and a tracking area code (TAC), e.g., PLMN-Identity+CellIdentity+TAC; or the cell related information may include a physical cell identity and a carrier frequency, e.g., PCI+ARFCN. For instance, partial or all latest configured CPAC candidate PSCells may be not included in the measurement results. For the CPAC candidate PSCells not included in the measurement results, e.g., which are not included in the measResultSCG-Failure or measResultListNR or measResultNeighCells IE, another IE may be introduced to include the cell related information of them.
(5) Latest measurement configurations, e.g., SCG measurement configurations for the CPAC procedure (e.g., measId(s) to be used for the CPAC procedure).

In Solution 1, if it is a MN initiated CPAC procedure, the MN may use the received CPAC configuration(s) for a MRO purpose after receiving SCG failure related information or failure related information associated with the CPAC procedure. Additionally, the MN may send the received CPAC configuration(s) to the last serving SN or the source SN via a newly defined Xn or X2 message or an existing message (e.g., a SCG FAILURE INFORMATION REPORT message), for example, for a SN initiated CPAC procedure. Then, the last serving SN or the source SN may use the received CPAC configuration(s) for a MRO analysis or optimization operation if needed.

Solution 2 refers to a network based solution. In Solution 2, in case that a SCG failure occurs shortly in a target PSCell after the successful CPAC execution, since a UE releases CPAC configuration(s) after the successful CPAC execution, the CPAC configuration(s) configured by a network cannot be reported by the UE. On the other hand, the network may have released the UE's context (e.g., including CPAC configuration(s)). Also, there may be a case that the UE's context (e.g., source PSCell related UE's context) is released in the MN when the MN receives SCG failure related information. Or, there may be a case that the UE's context (e.g., source PSCell related UE context) is released in the source SN (i.e., S-SN) when the MN transfers SCG failure related information to the source SN. To enable that the MN or the source SN has sufficient CPAC configuration(s) to analyse a failure, there may be following two solutions, i.e., Solution 2-1 and Solution 2-2.

Solution 2-1: Optionally, a source SN may send one container (e.g., reusing the existing SN Mobility Information IE to represent the container, or use an index to represent the container) to the MN via an existing message (e.g., a S-NODE modification required message, a SGNB modification required message, a S-NODE release request ACK message, a SGNB release request ACK message, or a SN status transfer message) or via a newly defined Xn or X2 message. SN mobility information IE is used to illustrate information related to the CPAC procedure. The source SN may provide the container, e.g., SN mobility information or an index, in order to enable later analysis of the reasons which caused the SCG failure.

In Solution 2-1, in specific implementations, a container (e.g., SN mobility information or an index) may be used to map or match with the UE's context (e.g., parameters for CPAC, at least including the latest configured CPAC execution condition(s) for each accepted CPAC candidate PSCells, the corresponding latest SCG measurement configurations for CPAC (e.g., measId(s) to be used for CPAC), a list of the configured CPAC candidate PSCells accepted by candidate target SNs, and/or the upper limit for the number of PSCells).

In Solution 2-1, after a MN receives SCG failure related information or failure related information associated with a CPAC procedure or a SCG failure information message, besides SCG failure related information, e.g., which is included in SCG Failure Information message or an RLF report, MN can send the container (e.g., SN Mobility Information or an index) back to the S-SN, e.g., via a new defined Xn or X2 message or the existing SCG FAILURE INFORMATION REPORT message. Then, based on the container (e.g., SN Mobility Information or an index), S-SN can analyse root cause and modify CPAC related parameters if needed.

Solution 2-2: Optionally, a source SN may send following information to a MN via an existing message (e.g., a S-NODE modification required message, a SGNB modification required message, a S-NODE release request ACK message, a SGNB release request ACK message, or SN status transfer message) or via a newly defined Xn or X2 message:
(1) a list of the latest configured CPAC candidate PSCells, e.g., which are accepted by candidate target SN(s); for example, the list may include cell related information of the latest configured CPAC candidate PSCells; and the cell related information may include a global cell identity and a tracking area code (TAC), e.g., PLMN-Identity+CellIdentity+TAC; or the cell related information may include a physical cell identity and a carrier frequency, e.g., PCI+ARFCN;
(2) the latest CPAC configuration(s) which is configured for a CPAC candidate PSCell within the list of the latest configured CPAC candidate PSCells; for example, the latest CPAC configuration(s) may include the latest configured CPAC execution condition(s) (e.g., configuration related to CondEvent A3, A4, A5, B1 and/or B2 configuration, and/or TTT values) which is configured for any CPAC candidate PSCell;
(3) the latest SCG measurement configurations for CPAC (e.g., measId(s) to be used for CPAC); and/or
(4) the upper limit for the number of PSCells.

In Solution 2-2, after the MN receives SCG failure related information or failure related information associated with a CPAC procedure or the SCG failure information message, besides the SCG failure related information, e.g., which is included in the SCG failure information message or an RLF report, the MN may also send following information to the source SN, e.g., via a new defined Xn or X2 message or the existing SCG failure information report message:
(1) a list of the latest configured CPAC candidate PSCells, e.g., which are accepted by candidate target SN(s); for example, the list may include cell related information of the latest configured CPAC candidate PSCells; and the cell related information may include a global cell identity and a tracking area code (TAC), e.g., PLMN-Identity+CellIdentity+TAC; or the cell related information may include a physical cell identity and a carrier frequency, e.g., PCI+ARFCN;
(2) the latest CPAC configuration(s) which is configured for a CPAC candidate PSCell within the list of the latest configured CPAC candidate PSCells; for example, the latest CPAC configuration(s) may include the latest configured CPAC execution condition(s) (e.g., configuration related to CondEvent A3, A4, A5, B1 and/or B2 configuration, and/or TTT values) which is configured for any CPAC candidate PSCell;
(3) the latest SCG measurement configurations for CPAC (e.g., measId(s) to be used for CPAC); and/or
(4) the upper limit for the number of PSCells.

Then, based on the above information received from the MN, the source SN can analyse a root cause and modify CPAC related parameters if needed.

Embodiment 1-3: a UE may store, log, record, or generate identification information for a MRO purpose, or the UE may report identification information.

In particular, In Embodiment 1-3, considering that a legacy PSCell change or addition procedure and a CPAC procedure have different configuration(s), it is beneficial for a network to know the type of PSCell change or addition when performing a MRO analysis or optimization operation. For example, in case that a SCG failure occurs shortly in a target PSCell after the successful CPAC execution, since a UE releases CPAC configuration(s) after the successful CPAC execution, no CPAC specific parameters can be reported by the UE to the network. Thus, the UE may store, log, record, or generate the type of PSCell change or addition procedure, e.g., the procedure where the SCG failure is happened is a CPAC procedure, then the UE may report this information. The UE may also store, log, record, or generate an indication to indicate the type of PSCell change or addition procedure, e.g., an indication to indicate whether the SCG failure is happened in a CPAC procedure or not, then the UE may report this information.

In Embodiment 1-3, to distinguish a SCG failure in a normal PSCell change procedure from a SCG failure in a CPC procedure (e.g., a failure means that a PSCell change failure or an RLF occurs in a target PSCell shortly after a successful PSCell change), a UE may store, log, record, or generate the type of PSCell change when the failure happens, or the UE may report the type of PSCell change. For instance, the type of PSCell change procedure is included in the SCG failure information message or an RLF report, e.g., an IE to represent the type of a CPC procedure is included in the SCG failure information message or an RLF report. In another solution, an explicit indication is added in the SCG failure information message or the RLF report, to indicate whether the last executed PSCell change before the SCG failure in the target PSCell was a CPC procedure or not, or to indicate whether the last executed PSCell change before the PSCell change failure was a CPC procedure or not, e.g., an indication to indicate whether the SCG failure is happened in a CPC procedure or not is included in the SCG failure information message or an RLF report.

In Embodiment 1-3, to differentiate a SCG failure in a normal PSCell addition procedure from a SCG failure in a CPA procedure, a UE may store, log, record, or generate the type of PSCell addition when a failure happens, e.g., the type of PSCell addition procedure is included in the SCG failure information message or an RLF report, or an IE to represent the type of a CPA procedure is included in the SCG failure information message or an RLF report. Then, the UE may report this information. In another solution, an explicit indication is added in the SCG failure information message or an RLF report, to indicate whether the last executed PSCell addition before the SCG failure was a CPA procedure or not, e.g., an indication to indicate whether the SCG failure is happened in a CPA procedure or not is included in the SCG failure information message or an RLF report. Then, the UE may report this information.

Some embodiments of the present application refer to information storing or reporting for failure cases in a CPAC procedure. In particular, during a CPAC procedure, following failure cases, i.e., Cases 1-4, can be considered for a MRO purpose.

In Case 1, a source SCG failure occurs before a CPAC execution. In Case 1, a UE stores or reports an indication to indicate that a SCG failure occurs before a CPAC execution. The UE may also store or report time elapsed from “reception of the latest conditional reconfiguration for a CPAC procedure” to “occurrence of a source SCG failure”, status information associated with CPAC triggering event(s) or condition(s) mentioned in Embodiment 1-1, CPAC related configuration(s) mentioned in Solution 1 in Embodiment 1-2, and/or identification information mentioned in Embodiment 1-3.

In Case 1, when the MN is available, the UE may send the above SCG failure related information to the MN, e.g., via a SCG failure information message.

In Case 1, when a MCG failure occurs upon a source SCG failure, the UE may send SCG and MCG failure related information (e.g., including above SCG failure related information, time elapsed from “occurrence of a SCG failure” to “occurrence of a MCG failure”, time elapsed from “occurrence of the MCG failure” to “the UE reporting failure related information”) to a third party node where the UE re-connects or re-establishes, e.g., via an RLF report.

In Case 2, a CPAC execution failure occurs. In Case 2, a UE stores or reports an indication to indicate a CPAC execution failure. The UE may also store or report the time elapsed between “the initiation of the last conditional reconfiguration execution towards the target PSCell” and “the reception of the latest conditional reconfiguration for the target PSCell”, the time elapsed between “the initiation of the last conditional reconfiguration execution towards the target PSCell” and “occurrence of the CPAC execution failure”, status information associated with CPAC triggering event(s) or condition(s) mentioned in Embodiment 1-1, CPAC related configuration(s) mentioned in Solution 1 in Embodiment 1-2, and/or identification information mentioned in Embodiment 1-3.

In Case 2, when the MN is available, the UE may send the above SCG failure related information to the MN, e.g., via a SCG failure information message.

In Case 2, when a MCG failure upon a CPAC execution failure, the UE may send SCG and MCG failure related information (e.g., including above SCG failure related information, time elapsed from a CPAC execution failure to a MCG failure, time elapsed from a MCG failure to reporting failure related information) to a third party node where the UE re-connects or re-establishes, e.g., via an RLF report.

In Case 3, a SCG failure occurs shortly after the successful CPAC execution. In Case 3, a UE stores or reports an indication to indicate that an RLF in a target PSCell occurs shortly after the CPAC execution. The UE may also store or report the type of PSCell change/addition procedure (i.e., it is a CPAC procedure), the time elapsed between “the initiation of the last conditional reconfiguration execution towards the target PSCell” and “the reception of the latest conditional reconfiguration for the target PSCell”, and the time elapsed between “the initiation of the last conditional reconfiguration execution towards the target PSCell” and “occurrence of the RLF in the target SCG”, status information associated with CPAC triggering event(s) or condition(s) mentioned in Embodiment 1-1, and identification information mentioned in Embodiment 1-3. For CPAC related configuration(s), Solution 2 (a network based solution) mentioned in Embodiment 1-2 may be used.

In Case 3, when a MN is available, the UE may send the above SCG failure related information to MN, e.g., via a SCG failure information message.

In Case 3, when the MCG failure upon the SCG failure shortly after successful CPAC execution, the UE may send SCG and MCG failure related information (e.g., including the above SCG failure related information, time elapsed from “occurrence of an RLF in a target SCG” to “occurrence of a MCG failure”, time elapsed from “occurrence of a MCG failure” to “the UE reporting failure related information”) to a third party node where the UE re-connects or re-establishes, e.g., via an RLF report.

In Case 4, a MCG failure occurs before a CPAC execution. Conditional reconfiguration evaluation for a CPAC procedure may be stopped upon the MCG failure. In Case 4, a UE may store or report an indication to indicate that MCG failure before CPAC execution. The UE may also store or report time elapsed from reception of the latest conditional reconfiguration for CPAC to MCG failure, status information associated with CPAC triggering event(s)/condition(s) mentioned in Embodiment 1-1, CPAC related configuration(s) mentioned in Embodiment 1-2, identification information mentioned in Embodiment 1-3.

In Case 4, when the source SN is available, the UE may send the above MCG failure related information to the source SN, e.g., via a MCG failure information message.

In Case 4, when a SCG failure upon a MCG failure, the UE may send SCG and MCG failure related information (e.g., including above MCG failure related information, time elapsed from MCG failure to SCG failure, time elapsed from SCG failure to reporting failure related information) to a third party node where the UE re-connects or re-establishes, e.g., via an RLF report.

In Case 5, a MCG failure occurs during a CPAC execution. There may be following options in Case 5, Option A and Option B.

In Option A of Case 5, a UE may continue a CPAC execution when a MCG failure occurs during the CPAC execution. In particular, if CPAC is successful, UE may send a MCG failure information message to T-SN, e.g., via SRB3 or split SRB1. The MCG failure information message may include time elapsed from “reception of the latest conditional reconfiguration for the CPAC procedure” to “the CPAC execution”, time elapsed from “the CPAC execution” to “occurrence of the MCG failure”, time elapsed from “occurrence of the MCG failure” to “the CPAC execution is successful”, and/or time elapsed from “the CPAC execution is successful” to “the UE reporting the MCG failure information message”. The MCG failure information message may also include status information associated with CPAC triggering event(s) or condition(s) mentioned in Embodiment 1-1, CPAC related configuration(s) mentioned in Embodiment 1-2, an indication for indicating the MCG failure during a CPAC execution phase, and/or an indication for indicating that the CPAC procedure is successful after the MCG failure.

In Option A of Case 5, if the CPAC procedure fails, the UE may send MCG and SCG failure related information to a third party node where the UE re-connects or re-establishes. For instance, the MCG and SCG failure related information may include time elapsed from “reception of the latest conditional reconfiguration for CPAC” to “the CPAC execution”, time elapsed from “the CPAC execution” to “occurrence of the MCG failure”, time elapsed from “occurrence of the MCG failure” to “occurrence of the CPAC execution failure”, and/or time elapsed from “occurrence of the CPAC execution failure” to “the UE reporting the MCG and SCG failure related information”) Also, the MCG and SCG failure related information may include status information associated with CPAC triggering event(s) or condition(s) mentioned in Embodiment 1-1, CPAC related configuration(s) mentioned in Embodiment 1-2, identification information mentioned in Embodiment 1-3, an indication for indicating the MCG failure during CPAC execution phase, and/or an indication for indicating that the CPAC procedure fails after the MCG failure.

In Option B of Case 5, a UE may stop a CPAC execution when a MCG failure occurs during the CPAC execution, and performs an RRC re-establishment or establishment. In particular, the UE may send MCG failure related information to a third party node where the UE re-connects or re-establishes, via an RLF report. For example, the MCG failure related information may include time elapsed from “reception of the latest conditional reconfiguration for a CPAC procedure” to “a CPAC execution”, time elapsed from “the CPAC execution” to “occurrence of a MCG failure”, and/or time elapsed from “occurrence of the MCG failure” to “the UE reporting the MCG failure related information”. The MCG failure related information may also include status information associated with CPAC triggering event(s) or condition(s) mentioned in Embodiment 1-1, CPAC related configuration(s) mentioned in Embodiment 1-2, identification information mentioned in Embodiment 1-3, an indication for indicating the MCG failure during the CPAC execution phase, and/or an indication for indicating that the CPAC procedure is stopped.

FIG. 5 illustrates an exemplary flowchart of CPAC failure information exchange in a network in accordance with some embodiments of the present application. In CU-DU split architecture, a CU and/or a DU may perform a MRO analysis or optimization operation based on the received failure related information associated with a CPAC procedure or CPAC failure related information. The exemplary procedure 500 refers to a flow for signalling of CPAC failure related information between RAN nodes, e.g., from gNB-CU to gNB-DU.

In operation 511, UE 501 with stored failure related information associated with a CPAC procedure (which may also be called as CPAC failure related information) and/or MCG failure related information, connects to a cell in a BS (e.g., MN 504). UE 501 may signal the CPAC failure related information and/or MCG failure related information as mentioned in the embodiments of FIGS. 2-4 to MN 504. UE 501 may send a SCG failure information message to MN 504 which includes the CPAC failure related information and/or the MCG failure related information as mentioned in the embodiments of FIGS. 2-4. If MN 504 is of a CU-DU split architecture, a CU of MN 504 may also send a F1 message, e.g., an access and mobility indication message, to at least one DU of MN 504 which is managed by the CU of MN 504, including the CPAC failure related information and/or the MCG failure related information as mentioned in the embodiments of FIGS. 2-4. Based on received CPAC failure related information and/or the MCG failure related information, the CU and/or the DU of MN 504 shall take it into account for optimisation of CPAC procedures if needed, e.g., to decide whether or how to modify CPAC related configuration (e.g., RSRP or RSRQ or SINR threshold for CPAC execution condition(s), and/or TTT for CPAC evaluation), for example, for a MN initiated CPAC procedure.

In operation 512, NG-RAN nodes may exchange the CPAC failure related information for CPAC procedure via the SCG failure information report message. For example, MN 504 sends an Xn or X2 message, e.g., a SCG failure information report message, to a CU of another BS (e.g., SN CU 503) in operation 512. For instance, for a SN initiated PSCell change or CPAC procedure, the SN may be the last serving SN or a source SN. The SCG failure information report message includes the CPAC failure related information as mentioned in the embodiments of FIGS. 2-4.

In operation 513, based on the received CPAC failure related information, SN CU 503 may take it into account for optimisation of CPAC procedures if needed, e.g., decides whether or how to modify CPAC related configuration (e.g., RSRP or RSRQ or SINR threshold for the CPAC execution condition(s), and/or TTT for CPAC evaluation), for example, for the case that the failure is due to a CPAC execution failure.

In operation 514, SN CU 503 sends a F1 message, e.g., an access and mobility indication message to at least one DU, e.g., SN DU 502 which is managed by SN CU 503, including the CPAC failure related information as mentioned in the embodiments of FIGS. 2-4. For example, for the case that UE 501 experiences a random access problem indication from the SCG MAC in SN DU 502 while timer T304 is running for the SCG (i.e., when the failure type is randomAccessProblem which is included in the SCG failure information message or a SCG failure information report message), SN CU 503 may send the F1 message, e.g., an access and mobility indication message, to SN DU 502.

In operation 515, based on the received CPAC failure related information, SN DU 502 shall take it into account for optimisation of the CPAC procedures if needed, e.g., to decide whether or how to modify RACH configuration(s) towards a target PSCell managed by SN DU 502 when SN DU 502 is a DU of the target BS for the CPAC execution.

FIG. 6 illustrates an exemplary block diagram of an apparatus 600 for a CPAC procedure in accordance with some embodiments of the present application.

As shown in FIG. 6, the apparatus 600 may include at least one non-transitory computer-readable medium 602, at least one receiving circuitry 604, at least one transmitting circuitry 606, and at least one processor 608 coupled to the non-transitory computer-readable medium 602, the receiving circuitry 604 and the transmitting circuitry 606. The at least one processor 608 may be a CPU, a DSP, a microprocessor etc. The apparatus 600 may be a network node (e.g., a MN or a SN) configured to perform a method illustrated in the above or the like.

Although in this figure, elements such as the at least one processor 608, receiving circuitry 604, and transmitting circuitry 606 are described in the singular, the plural is contemplated unless a limitation to the singular is explicitly stated. In some embodiments of the present application, the receiving circuitry 604 and the transmitting circuitry 606 can be combined into a single device, such as a transceiver. In certain embodiments of the present application, the apparatus 600 may further include an input device, a memory, and/or other components.

In some embodiments of the present application, the non-transitory computer-readable medium 602 may have stored thereon computer-executable instructions to cause a processor to implement the methods with respect to a network node (e.g., a UE, a MN, or a SN) as described or illustrated above. For example, the computer-executable instructions, when executed, cause the processor 608 interacting with receiving circuitry 604 and transmitting circuitry 606, so as to perform the steps with respect to a network node (e.g., a UE, a MN, or a SN) as described or illustrated above.

FIG. 7 illustrates a further exemplary block diagram of an apparatus 700 for a CPC procedure in accordance with some embodiments of the present application. Referring to FIG. 7, the apparatus 700, for example a UE, a MN, or a SN, may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some other embodiments of the present application, when the apparatus 700 is a UE, the processor 702 may be configured to perform at least one of: storing failure related information associated with a conditional primary secondary cell group cell (PSCell) addition or change (CPAC) procedure, wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or transmitting the failure related information via the transceiver 704 to a network.

According to some embodiments of the present application, when the apparatus 700 is a MN, the processor 702 is configured to perform at least one of: receiving failure related information associated with a conditional primary secondary cell group (PSCell) addition or change (CPAC) procedure via the transceiver 704 from a user equipment (UE), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; performing a mobility robustness optimization (MRO) analysis or optimization operation for parameters related to the CPAC procedure; or transmitting the failure related information via the transceiver 704 to a secondary node (SN).

According to some embodiments of the present application, when the apparatus 700 is a source SN, the processor 702 is configured to perform at least one of: receiving failure related information associated with a conditional primary secondary cell group (PSCell) addition or change (CPAC) procedure via the transceiver 704 from a master node (MN), wherein the failure related information includes at least one of: time information associated with the CPAC procedure; status information associated with one or two triggering events configured for a candidate PSCell of the CPAC procedure; configuration information related to the CPAC procedure; or identification information associated with the CPAC procedure; or performing a mobility robustness optimization (MRO) analysis or optimization operation for parameters related to the CPAC procedure.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. A user equipment (UE) for wireless communication, comprising:
at least one memory; and
at least one processor coupled with the at least one memory and configured to cause the UE to:
store failure related information associated with a conditional primary secondary cell group cell (PSCell) addition or change (CPAC) procedure, wherein the failure related information includes
status information associated with one or more of a first triggering event or a second triggering event configured for a candidate PSCell of the CPAC procedure; and
transmit the failure related information to a network.

2. The UE of claim 1, wherein the failure related information further includes time information associated with the CPAC procedure, and wherein the time information includes at least one of:
time elapsed between initiation of last conditional reconfiguration execution towards a target PSCell and reception of latest conditional reconfiguration for the target PSCell;
time elapsed between occurrence of a secondary cell group (SCG) failure when the UE is connected to a source PSCell and the reception of latest conditional reconfiguration for the CPAC procedure; or
time elapsed between the initiation of the last conditional reconfiguration execution towards the target PSCell and the SCG failure.

3. The UE of claim 1, wherein in response to occurrence of a secondary cell group (SCG) failure, the status information includes at least one of:
information regarding the first triggering event in response to fulfillment of the first triggering event;
information regarding the second triggering event in response to fulfillment of the second triggering event; or
time duration between fulfilment timing of the first triggering event and fulfilment timing of the second triggering event.

4. The UE of claim 1, wherein the failure related information further includes configuration information related to the CPAC procedure, and wherein the configuration information includes at least one of:
a list of configured candidate PSCells of the CPAC procedure;
one or more triggering events configured for a candidate PSCell within the list of configured candidate PSCells;
an indication for indicating whether a measured neighbour PSCell is the candidate PSCell; or
one or more measurement configurations configured for the CPAC procedure.

5. The UE of claim 1, wherein the failure related information further includes identification information, and wherein the identification information includes at least one of:
a type of a PSCell change operation executed during the CPAC procedure;
a type of a PSCell addition operation executed during the CPAC procedure;
an indication for indicating that the PSCell change operation is executed during the CPAC procedure;
an indication for indicating that the PSCell addition operation is executed during the CPAC procedure;
an indication for indicating whether a last executed PSCell change operation is a conditional PSCell change (CPC) operation; or
an indication for indicating whether a last executed PSCell addition operation is a conditional PSCell addition (CPA) operation.

6. The UE of claim 1, wherein the at least one processor is configured to cause the UE to transmit at least one of:
an indication for indicating occurrence of a SCG failure before initiation of conditional reconfiguration execution towards a target PSCell;
an indication for indicating occurrence of a master cell group (MCG) failure before the initiation of the conditional reconfiguration execution towards the target PSCell;
an indication for indicating occurrence of a failure during the conditional reconfiguration execution towards the target PSCell; or
an indication for indicating an RLF in the candidate PSCell occurring shortly after a completion of the conditional reconfiguration execution towards the target PSCell.

7. The UE of claim 1, wherein at least one processor is configured to cause the UE to transmit an indication for indicating an optional capability of the UE for storing or transmitting the failure related information.

8. A master node (MN) for wireless communication, comprising:
at least one memory; and
at least one processor coupled with the at least one memory and configured to cause the MN to:
receive failure related information associated with a conditional primary secondary cell group (PSCell) addition or change (CPAC) procedure from a user equipment (UE), wherein the failure related information includes
status information associated with one or more of a first triggering event or a second triggering event configured for a candidate PSCell of the CPAC procedure; and
transmit the failure related information to a secondary node (SN).

9. The MN of claim 8, wherein the failure related information further includes time information associated with the CPAC procedure, and wherein the time information includes at least one of:
time elapsed between initiation of last conditional reconfiguration execution towards a target PSCell and reception of latest conditional reconfiguration for the target PSCell;
time elapsed between occurrence of a secondary cell group (SCG) failure when the UE is connected to a source PSCell and the reception of latest conditional reconfiguration for the CPAC procedure; or
time elapsed between the initiation of the last conditional reconfiguration execution towards the target PSCell and the SCG failure.

10. The MN of claim 8, wherein the status information includes at least one of:
information regarding the first triggering event in response to fulfillment of the first triggering event;
information regarding the second triggering event in response to fulfillment of the second triggering event; or
time duration between fulfilment timing of the first triggering event and fulfilment timing of the second triggering event.

11. The MN of claim 8, wherein the failure related information further includes configuration information, and wherein the configuration information includes at least one of:
a list of configured candidate PSCells of the CPAC procedure;
one or more triggering events configured for a candidate PSCell within the list of configured candidate PSCells;
an indication for indicating whether a measured neighbour PSCell is the candidate PSCell; or
one or more measurement configurations configured for the CPAC procedure.

12. The MN of claim 8, wherein the at least one processor is configured to cause the MN to receive one or more of:
one or more CPAC configurations; or
a container associated with the one or more CPAC configurations.

13. The MN of claim 12, wherein the one or more CPAC configurations include at least one of:
a list of configured candidate PSCells of the CPAC procedure; or
one or more triggering events configured for a candidate PSCell within the list of configured candidate PSCells.

14. The MN of claim 12, wherein the at least one processor is configured to cause the MN to transmit at least one of the one or more CPAC configurations or the container to the SN.

15. (canceled)

16. A processor for wireless communication, comprising:
at least one controller coupled with at least one memory and configured to cause the processor to:
store failure related information associated with a conditional primary secondary cell group cell (PSCell) addition or change (CPAC) procedure, wherein the failure related information includes status information associated with one or more of a first triggering event or a second triggering event configured for a candidate PSCell of the CPAC procedure; and
transmit the failure related information to a network.

17. The processor of claim 16, wherein the failure related information further includes time information associated with the CPAC procedure, and wherein the time information includes at least one of:
time elapsed between initiation of last conditional reconfiguration execution towards a target PSCell and reception of latest conditional reconfiguration for the target PSCell;
time elapsed between occurrence of a secondary cell group (SCG) failure when a user equipment (UE) is connected to a source PSCell and the reception of latest conditional reconfiguration for the CPAC procedure; or
time elapsed between the initiation of the last conditional reconfiguration execution towards the target PSCell and the SCG failure.

18. The processor of claim 16, wherein in response to occurrence of a secondary cell group (SCG) failure, the status information includes at least one of:
information regarding the first triggering event in response to fulfillment of the first triggering event;
information regarding the second triggering event in response to fulfillment of the second triggering event; or
time duration between fulfilment timing of the first triggering event and fulfilment timing of the second triggering event.

19. The processor of claim 16, wherein the failure related information further includes configuration information related to the CPAC procedure, and wherein the configuration information includes at least one of:
a list of configured candidate PSCells of the CPAC procedure;
one or more triggering events configured for a candidate PSCell within the list of configured candidate PSCells;
an indication for indicating whether a measured neighbour PSCell is the candidate PSCell; or
one or more measurement configurations configured for the CPAC procedure.

20. The processor of claim 16, wherein the failure related information further includes identification information, and wherein the identification information includes at least one of:
a type of a PSCell change operation executed during the CPAC procedure;
a type of a PSCell addition operation executed during the CPAC procedure;
an indication for indicating that the PSCell change operation is executed during the CPAC procedure;
an indication for indicating that the PSCell addition operation is executed during the CPAC procedure;
an indication for indicating whether a last executed PSCell change operation is a conditional PSCell change (CPC) operation; or
an indication for indicating whether a last executed PSCell addition operation is a conditional PSCell addition (CPA) operation.

21. A user equipment (UE) for wireless communication, comprising:
at least one memory; and
at least one processor coupled with the at least one memory and configured to cause the UE to:
generate, based at least in part on a successful conditional primary secondary cell group cell (PSCell) addition or change (CPAC) procedure, an information element that indicates a time elapsed between an initiation of a last conditional reconfiguration execution towards a target PSCell and a reception of a latest conditional reconfiguration for the target PSCell for the CPAC procedure; and
transmit the information element.
